(19) United States
(12) Patent Application Publication
(10) Pub. No.: US 2012/0280948 A1
(43) Pub. Date: Nov. 8, 2012

(54) INTERACTIVE WHITEBOARD USING DISAPPEARING WRITING MEDIUM

(75) Inventors: John Barrus, Menlo Park, CA (US); Gregory J. Wolff, Palo Alto, CA (US); Jonathan J. Hull, San Carlos, CA (US)

(73) Assignee: Ricoh Company, Ltd., Tokyo (JP)

(21) Appl. No.: 13/102,963

(22) Filed: May 6, 2011

(51) Int. Cl. G06F 3/033

(52) U.S. Cl. 345/179

(57) ABSTRACT

Techniques for enabling interactive whiteboard functionality using a disappearing writing medium. In one set of embodiments, an image of a surface can be received, where the image can include one or more physical marks made on the surface by a user. The physical marks can be made using a writing medium that is configured to disappear over time. Electronic representations of the physical marks can be generated based on the image, and the electronic representations can be displayed on the surface. The electronic representations can be displayed such that they visually replace the physical marks made on the surface as the physical marks fade and disappear.

### BACKGROUND

Embodiments of the present invention relate in general to interactive whiteboard systems, and in particular to techniques for enabling interactive whiteboard functionality using a disappearing writing medium, such as disappearing ink.

Interactive whiteboard (IWB) systems are commonly used for capturing and sharing hand-written information in electronic form. Almost all conventional IWB systems require special instrumentation (e.g., in the whiteboard and/or in the instrument used to write on the whiteboard) in order to electronically capture a user's hand-written strokes. For instance, one type of conventional IWB system incorporates touch sensors in the whiteboard for detecting the location of a user's finger on the whiteboard surface. Generally speaking, such specialized whiteboards can be costly to procure and maintain.

Some electronic whiteboard systems have been developed that can make use of a regular (i.e., non-instrumented) whiteboard surface. In these systems, a user writes on the whiteboard using a conventional dry-erase marker, and the user's writings are captured via a camera that is pointed at the whiteboard. The captured writings are then converted into an electronic representation that is stored or shared with others. However, since the user's writings persist on the whiteboard, these electronic whiteboard systems generally do not allow the electronic representation to be displayed and interacted with on the whiteboard surface.

### BRIEF SUMMARY

Embodiments of the present invention provide techniques for enabling interactive whiteboard functionality using a disappearing writing medium. In one set of embodiments, an image of a surface can be received, where the image can include one or more physical marks made on the surface by a user. The physical marks can be made using a writing medium that is configured to disappear over time. Electronic representations of the physical marks can be generated based on the image, and the electronic representations can be displayed on the surface. The electronic representations can be displayed such that they visually replace the physical marks made on the surface as the physical marks fade and disappear.

Since the physical marks made on the surface do not persist, the user can manipulate the displayed electronic representations (e.g., translate, scale, rotate, delete, etc.) without having to manually erase the physical marks from the surface. Further, since the physical marks made on the surface can be captured optically (e.g., during the period of time that they are visible), the surface does not need any special instrumentation to capture the user's writings/drawings in electronic form.

According to one embodiment of the present invention, a method is provided that includes receiving, by a computer system, a first image of a surface, the first image including a first physical mark made on the surface by a user, the first mark being made using a writing medium configured to disappear over time; determining, by the computer system based on the first image, an electronic representation of the first physical mark; and generating, by the computer system, a video signal that includes the electronic representation of the first physical mark. The computer system then causes the video signal to be displayed on the surface, where the electronic representation of the first physical mark visually replaces the first physical mark on the surface as the first physical mark disappears.

In one embodiment, the video signal is displayed on the surface such that the electronic representation of the first physical mark appears at the same location on the surface that the first physical mark was originally made by the user.

In one embodiment, the method further includes determining a time at which the first physical mark starts to disappear.

In one embodiment, the video signal is generated such that the electronic representation of the first physical mark starts to fade into view on the surface at the time at which the first physical mark starts to disappear.

In one embodiment, the method further includes determining a rate of disappearance of the first physical mark.

In one embodiment, the video signal is generated such that the electronic representation of the first physical mark fades into view on the surface at a rate corresponding to the rate of disappearance of the first physical mark.

In one embodiment, the rate of disappearance is determined based on information pertaining to the writing medium.

In one embodiment, the information pertaining to the writing medium comprises a color of the writing medium or a manufacturer of the writing medium.

In one embodiment, the video signal is generated such that, for at least one frame per second, the video signal does not include the electronic representation of the first physical mark.

In one embodiment, the method further includes receiving a second image of the surface, the second image including a second physical mark made on the surface by the user, the second physical mark being made using the writing medium; determining, based on the second image, an electronic representation of the second physical mark; generating an updated video signal that includes the electronic representation of the first physical mark and the electronic representation of the second physical mark; and causing the updated video signal to be displayed on the surface.

In one embodiment, the second image is captured by a camera during the at least one frame where the video signal does not include the electronic representation of the first physical mark.

In one embodiment, the electronic representation of the second physical mark visually replaces the second physical mark on the surface as the second physical mark disappears.

In one embodiment, the method further includes transmitting the electronic representation of the first physical mark to a remote system.

In one embodiment, the writing medium is disappearing ink.

In one embodiment, the writing medium is configured to remain visible for at least one second and to disappear within ten seconds.

In one embodiment, the surface is a conventional whiteboard.

In one embodiment, causing the video signal to be displayed on the surface comprises transmitting the video signal to a projector for projection onto the surface.

In one embodiment, the surface is an LCD display, and causing the video signal to be displayed on the surface comprises transmitting the video signal to the LCD display.

According to another embodiment of the present invention, a non-transitory computer-readable storage medium is provided that has stored thereon program code executable by a processor. The program code comprises code that causes the processor to receive an image of a surface, the image including a physical mark made on the surface by a user, the physical mark being made using a writing medium that is configured to disappear over time; code that causes the processor to determine, based on the image, an electronic representation of the physical mark; code that causes the processor to generate a video signal that includes the electronic representation of the physical mark; and code that causes the processor to transmit the video signal for display on the surface, where the electronic representation of the physical mark visually replaces the physical mark on the surface as the physical mark disappears.

According to another embodiment of the present invention, a system is provided that comprises a processor. The processor is configured to receive an image of a surface, the image including a physical mark made on the surface by a user, the physical mark being made using a writing medium configured to disappear over time; determine, based on the image, an electronic representation of the physical mark; generate a video signal that includes the electronic representation of the physical mark; and cause the video signal to be displayed on the surface, where the electronic representation of the physical mark visually replaces the physical mark on the surface as the physical mark disappears.

The foregoing, together with other features and embodiments, will become more apparent when referring to the following specification, claims, and accompanying drawings.

### BRIEF DESCRIPTION OF THE DRAWINGS

FIG. 1 is a simplified block diagram of an IWB system in accordance with an embodiment of the present invention.

FIGS. 2A-2C are simplified depictions of a surface of an IWB system in accordance with an embodiment of the present invention.

FIG. 3 is a simplified block diagram of an environment in which multiple IWB systems can be networked in accordance with an embodiment of the present invention.

FIGS. 4-7 are flow diagrams of processes that can be performed by a controller of an IWB system in accordance with an embodiment of the present invention.

FIG. 8 is a simplified block diagram of a computer system in accordance with an embodiment of the present invention.

### DETAILED DESCRIPTION

In the following description, for the purposes of explanation, numerous details are set forth in order to provide an understanding of embodiments of the present invention. It will be apparent, however, to one of ordinary skill in the art that certain embodiments can be practiced without some of these details.

Embodiments of the present invention provide techniques for enabling interactive whiteboard functionality using a disappearing writing medium. In one set of embodiments, an image of a surface can be received, where the image can include one or more physical marks made on the surface by a user. The physical marks can be made using a writing medium that is configured to disappear over time. Electronic representations of the physical marks can be generated based on the image, and the electronic representations can be displayed on the surface. The electronic representations can be displayed such that they visually replace the physical marks made on the surface as the physical marks fade and disappear.

Since the physical marks made on the surface do not persist, the user can manipulate the displayed electronic representations (e.g., translate, scale, rotate, delete, etc.) without having to manually erase the physical marks from the surface. Further, since the physical marks made on the surface can be captured optically (e.g., during the period of time that they are visible), the surface does not need any special instrumentation to capture the user's writings/drawings in electronic form.

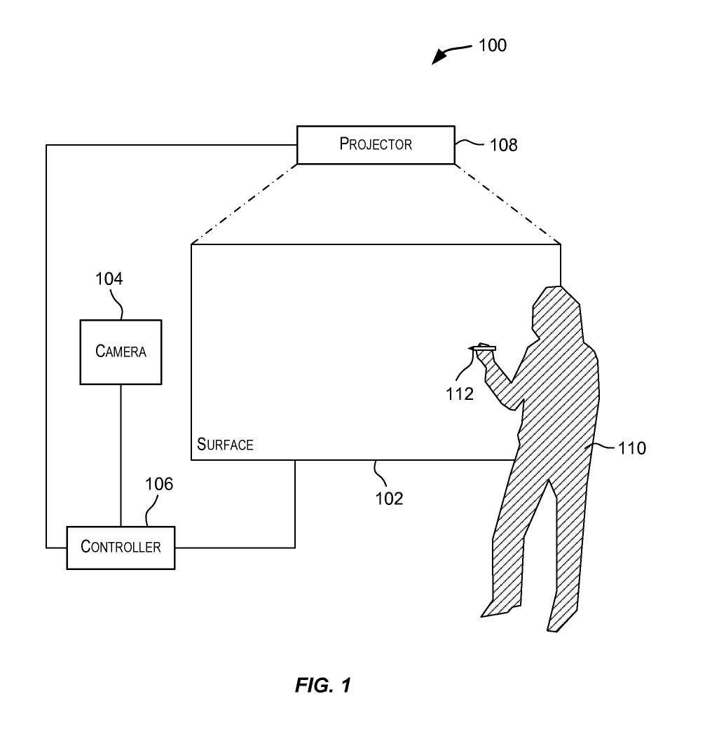

FIG. 1 is a simplified block diagram of an IWB system 100 according to an embodiment of the present invention. As shown, IWB system 100 can include a surface 102, a camera 104, a controller 106, and a projector 108.

Surface 102 can act as both an input and output interface for IWB system 100. As an input interface, surface 102 can receive one or more physical marks made by a user (e.g., user 110) using a writing instrument (e.g., writing instrument 112). These physical marks can be captured via camera 104. As an output interface, surface 102 can display a video signal that includes electronic representations of the physical marks. In certain embodiments, the video signal can be projected onto surface 102 by a projector, such as projector 108. In alternative embodiments, surface 102 can be a display device (e.g., an LCD display) that is configured to directly display the video signal.

For the purposes of the present disclosure, the phrase “physical mark” can refer to any kind of visible indication that is written or drawn on a surface using a tangible writing medium. In one set of embodiments, a physical mark or a group of physical marks can correspond to a figure, sketch, or illustration. In another set of embodiments, a physical mark or a group of physical marks can correspond to letters, numbers, or symbols, expressed in any language or format. In yet another set of embodiments, a physical mark or a group of physical marks can correspond to a combination of pictorial and textual elements.

Surface 102 can be implemented using any type of board, screen, or other physical medium that can be written/drawn on by a user and can display information on the surface. In one set of embodiments, surface 102 can be a conventional whiteboard. In another set of embodiments, surface 102 can be an electronic display, such as an LCD display/screen.

As indicated above, user 110 can write/draw on surface 102 using writing instrument 112. Writing instrument 112 can be any type of instrument usable for defining physical marks on surface 102, such as a marker, pen, brush, or the like. In a particular set of embodiments, writing instrument 112 can employ a disappearing writing medium—in other words, a writing medium that is designed to disappear over time. Accordingly, physical marks made with writing instrument 112 can be initially visible when applied to surface 102, but then fade from view until they are no longer perceptible.

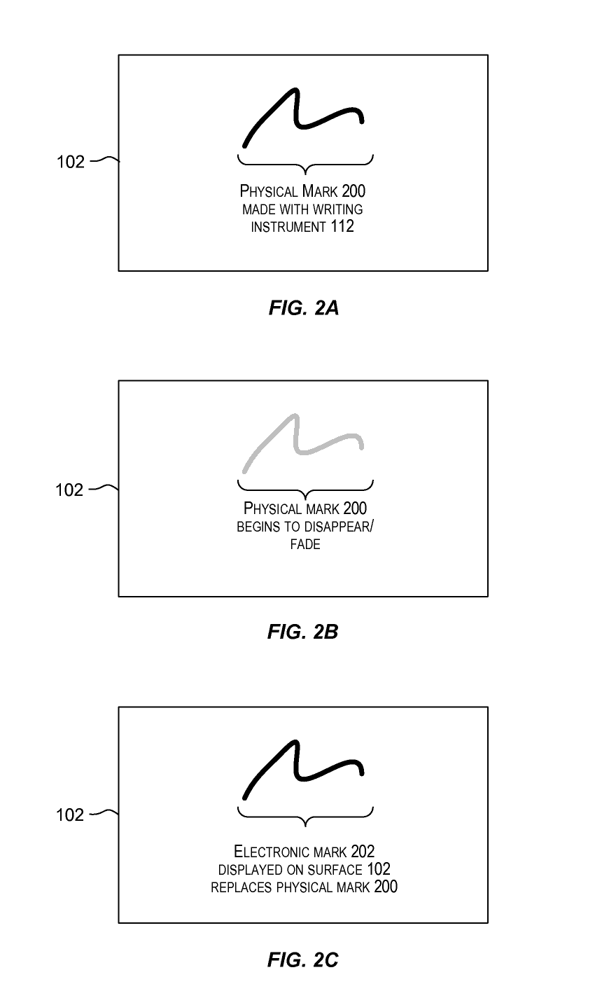

By way of example, FIGS. 2A and 2B illustrate a physical mark 200 made with writing instrument 112 on surface 102 where instrument 112 employs a disappearing writing medium. As shown in FIG. 2A, physical mark 200 is fully visible immediately after being applied to surface 102. However, as shown in FIG. 2B, physical mark 200 begins to fade after a period of time. Eventually, physical mark 200 can disappear entirely. In one set of embodiments, the disappearing writing medium used by writing instrument 112 can be configured to remain visible for at least one second after it is applied to a surface. In another set of embodiments, the disappearing writing medium can be configured to disappear within ten seconds, or some other relatively short period of time.

In certain embodiments, while physical mark 200 is still visible (as in FIG. 2A), the mark can be captured optically using, e.g., camera 104 of FIG. 1. As physical mark 200 fades from surface 102, it can be visually replaced by an electronic representation of the physical mark (electronic mark 202) that is displayed on surface 102 (shown in FIG. 2C). This process is described in greater detail below.

In one set of embodiments, the disappearing writing medium used by writing instrument 112 can be a disappearing ink. Disappearing inks are available in a variety of colors and include thymolphthalein-based (blue) inks, phenolphthalein-based (red) inks, and others. Information regarding how to make a disappearing ink, as well as the chemical properties of such inks, can be found in “Disappearing Ink” by David A. Katz, available at http://www.chymist.com/Disappearing%20Ink.pdf, which is incorporated herein by reference for all purposes.

In alternative embodiments, the disappearing writing medium used by writing instrument 112 can primarily comprise water or alcohol. In these embodiments, surface 102 can be configured to turn dark (or change color) at locations where it is exposed to moisture. Thus, when writing instrument 112 is used to write/draw on surface 102, the water or alcohol from the applied strokes can cause surface 102 to turn dark (or change color) at those locations and thereby display the user's writings/drawings. When the water or alcohol evaporates, the writings/drawings can disappear as surface 102 returns to its original brightness (or color).

In yet other embodiments, the disappearing writing medium can be embedded in surface 102 (rather than being dispensed by writing instrument 112). For instance, surface 102 can comprise a layer of material that changes color (or causes color to appear) at locations where an external stimulus is applied (e.g., pressure). Thus, when writing instrument 112 (or some other instrument, such as user 110's finger) is used to write/draw on surface 102, the stimulus from the applied strokes can cause this material layer to change color at those locations and thereby display the user's writings/drawings. In these embodiments, the material layer can revert back to its original state after a period of time, which causes the writings/drawings to disappear. One example of such a “color change” or “color appear” layer can be found in pressure-sensitive cholesteric LCDs, such as the LCDs produced by Kent Displays.

Camera 104 can be a still-image or video capture device that is positioned in front of surface 102 and is configured to capture a sequence of images (e.g., still-images or video frames) of surface 102. As noted above, in certain embodiments camera 104 can capture an image of surface 102 that includes physical marks made on the surface with writing instrument 112. This image can then be processed (e.g., by controller 106) to generate electronic representations of the physical marks (i.e., electronic marks). In a particular embodiment, camera 104 can be configured to capture a video stream of drawing surface 102 at a rate of 24, 30, or 60 frames per second. In another embodiment, camera 104 can be configured to capture still-images of drawing surface 102 at a rate of approximately one image per second.

Controller 106 can act as a central processing component for coordinating the various components of IWB system 100 and for enabling the functions provided by system 100. In one set of embodiments, controller 106 can be implemented using a computer system such as system 800 described with respect to FIG. 8 below. In alternative embodiments, controller 106 can be implemented using a processor, a programmable logic device, or the like.

As shown in FIG. 1, controller 106 can be communicatively coupled with camera 104, projector 108, and/or surface 102. In one set of embodiments, controller 106 can receive one or more images from camera 104 that capture the state of surface 102. These images can include a physical mark made by user 110 on surface 102 with writing instrument 112. Controller 106 can then process the received images to identify the physical mark and to determine an electronic mark corresponding to the physical mark. For example, the electronic mark can be a raster or vector-based representation of the physical mark.

In some embodiments, the process of determining the electronic mark can include determining the directionality and/or timing of the physical mark. In these embodiments, controller 106 can, e.g., analyze the saturation of the physical mark as it appears in the images received from camera 104. Based on this information, controller 106 can determine the direction in which the physical mark was drawn, and/or the time at which it was drawn. This directionality and timing information can be stored by controller 106 with the electronic mark information.

Once controller 106 has identified the physical mark and generated a corresponding electronic mark, controller 106 can generate a video signal, or update a previously generated video signal, such that the signal includes the electronic mark. Controller 106 can then cause the generated/updated video signal to be displayed on surface 102. As described above, in certain embodiments writing instrument 112 can employ a disappearing writing medium that causes physical marks made with instrument 112 to disappear over time. In these embodiments, the electronic mark can become visible on surface 102 once the physical mark has disappeared, thereby visually replacing the physical mark.

In one set of embodiments, controller 106 can configure the video signal such that the electronic mark gradually fades into view on surface 102 as the physical mark fades out of view. This can make the visual transition between the disappearing physical mark and the appearing electronic mark less obvious, and in some instances can give user 110 the impression that the physical mark never actually disappears. To achieve this, controller 106 can determine a time at which the physical mark begins to disappear, and/or a rate of disappearance of the mark. Controller 106 can then configure the video signal such that the electronic mark fades into view on surface 102 at a time and rate corresponding to the time and rate of disappearance of the physical mark.

In a particular embodiment, controller 106 can determine the time and rate of disappearance of the physical mark based on the time at which the physical mark was originally applied to surface 102. As described above, this timing information can be estimated by analyzing the saturation of the physical mark in the images captured by camera 104.

Alternatively, controller 106 can determine the time and rate of disappearance of the physical mark based on information regarding writing instrument 112 and/or the disappearing writing medium used by instrument 112. Examples of such information include the type of the disappearing writing medium, the color of the disappearing writing medium, and/or the manufacturer/brand of the writing instrument. In one embodiment, this information can be manually provided by user 110 to controller 106. In another embodiment, this information can be automatically determined by controller 106 by, e.g., analyzing the images captured by camera 104.

Once the physical mark has been visually replaced with the displayed electronic mark on surface 102, user 110 can interact with the displayed electronic mark by making further marks or strokes on surface 102 with writing instrument 112 (or another instrument, such as an erasing instrument). The further marks or strokes can be captured by camera 104 and processed by controller 106 to update the displayed video signal.

For example, if user 110 wishes to delete a portion of the electronic mark, user 110 can take an erasing instrument and move the instrument across the image of the electronic mark on surface 102. Camera 104 can capture images that track the movement of the erasing instrument across surface 102 and controller 106 can determine, based on those images, what portions of the electronic mark should be deleted. Controller 106 can then update the video signal displayed on surface 102 to include a modified version of the electronic mark that has appropriate portions removed. It should be appreciated that since the physical mark corresponding to the electronic mark is no longer visible on surface 102, user 110 does not need to manually erase the physical mark from surface 102 in order to erase the electronic mark.

In one set of embodiments, the erasing instrument can be any type of object that controller 106 can easily identify and track in the images captured by camera 104. For example, the erasing instrument can be an object with a specific shape and/or color, an object with a visible identifier (e.g., a barcode), or the like. Since all of the physical marks made on surface 102 with writing instrument 112 disappear over time, the erasing instrument does not need to be capable of erasing physical marks from surface 102.

In another set of embodiments, the erasing instrument can be similar to writing instrument 112 in that it applies a disappearing writing medium to surface 102. The disappearing writing medium used by the erasing instrument can have a particular quality (e.g., color, reflectivity, etc.) that controller 106 can identify as corresponding to “erasure marks.” When controller 106 identifies these erasure marks in images captured by camera 104, controller 106 can delete portions of electronic marks that fall within the bounds of the erasure marks. Like the physical marks made with writing instrument 112, the erasure marks made with the erasing instrument can disappear over time.

If user 110 wishes to manipulate the electronic mark (e.g., translate, rotate, scale, etc.), user 110 can place writing instrument 112 (or another instrument, such as his/her finger) on or near the electronic mark and make one or more predefined strokes or movements. Camera 104 can capture images that track these strokes/movements and controller 106 can determine, based on the images, how the electronic mark should be manipulated. For example, controller 106 can determine that the electronic mark should be scaled by a certain scaling factor, or moved a certain distance from its original position. Controller 106 can then update the video signal displayed on surface 102 to reflect these changes.

If user 110 wishes to add further writings/drawings to surface 102, user 110 can make additional physical marks on surface 102 with writing instrument 112. These additional physical marks can be captured and converted into electronic marks as described above. In order to distinguish newly added physical marks from displayed electronic marks, in certain embodiments the video signal displayed on surface 102 can comprise at least one frame per second that does not include any electronic marks. This can allow camera 104 to capture, during that at least one frame, an image of surface 102 that only includes physical marks made on the surface. With this approach, controller 106 does not need to determine what portions of the image received from camera 104 comprise physical marks and what portions comprise displayed electronic marks.

Alternatively, camera 104 can capture an image of surface 102 that includes both electronic marks displayed on surface 102 and newly added physical marks. In these embodiments, controller 106 can subtract (using, e.g., conventional image processing techniques) the electronic marks from the captured image. By performing this subtraction operation, controller 106 can isolate the newly added physical marks in the image to facilitate conversion of those marks into electronic representations.

In certain embodiments, controller 106 can generate the video signal described above prior to identifying any physical marks on surface 102. For example, upon powering on IWB system 100, camera 104 can begin capturing images of surface 102 and controller 106 can begin processing the images to identify physical marks made on surface 102 with writing instrument 112. If surface 102 is clear and user 110 has not yet drawn on the surface with writing instrument 112, controller 106 will not identify any physical marks. In these situations, controller 106 can generate a video signal that simply comprises a white background, or some other information that user 110 wishes to have displayed on the drawing surface 102 (e.g., an image of a presentation slide or document, a video stream, etc.). Controller 106 can then cause the generated video signal to be displayed on surface 102. When user 110 makes a physical mark on surface 102 with writing instrument 112, controller 106 can identify the physical mark, generate an electronic mark based on the physical mark, and update the video signal to incorporate the electronic mark as described above.

Projector 108 can be any type of device capable of projecting a video signal or image onto surface 102. In various embodiments, projector 108 can receive a video signal from controller 106 that includes electronic marks corresponding to physical marks made by user 110 using writing instrument 112. Projector 108 can then project the video signal onto surface 102. In a particular embodiment, projector 108 can project the video signal such that the projected electronic marks appear at substantially the same location on surface 102 that the corresponding physical marks were originally made.

In one set of embodiments, projector 108 can be a front projector. In other embodiments, projector 108 can be a rear projector. In a specific embodiment, projector 108 can be an ultra-short-throw (UST) projector that has a throw ratio (defined as the distance of the projector lens to surface 102 divided by the width of the projected image) of less than, e.g., 0.4. An example of such a projector is the CP-AW250NM produced by Hitachi, Ltd.

As discussed above, in certain embodiments surface 102 can be a display device, such as an LCD display. In these embodiments projector 108 is not needed, since controller 106 can transmit the video signal to surface 102 for displaying the signal directly on the surface.

It should be appreciated that FIG. 1 is illustrative and not intended to limit embodiments of the present invention. For example, system 100 can have other capabilities or have more or fewer components than those depicted in FIG. 1. One of ordinary skill in the art will recognize other variations, modifications, and alternatives.

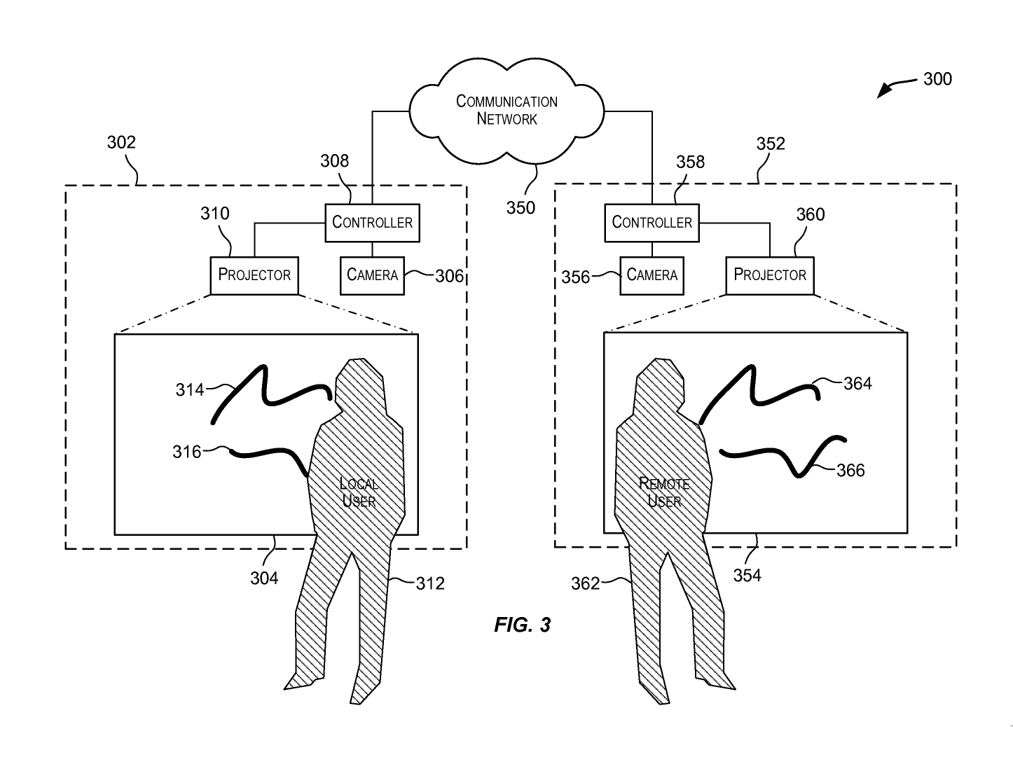

In certain embodiments, IWB system 100 of FIG. 1 can be networked with another IWB system to enable interactive sharing of drawings/writings between the two systems. FIG. 3 is a simplified block diagram of an environment 300 in which multiple IWB systems can be networked according to an embodiment of the present invention.

As shown, environment 300 can include a local IWB system 302 communicatively coupled with a remote IWB system 352 via a communication network 350. Local IWB system 302 and remote IWB system 352 can each be substantially similar in configuration to IWB system 100 of FIG. 1. For example, IWB systems 302 and 352 can each include respective surfaces (304, 354), cameras (306, 356), controllers (308, 358), and projectors (310, 360). IWB systems 302 and 352 can also include other components that are not specifically depicted, such as video/audio input devices to enable teleconferencing and/or videoconferencing.

Communication network 350 can be any type of network that enables data communication, such as a local area network (LAN), a wide-area network (WAN), a virtual network (e.g., VPN), a metro-area network (MAN), or the Internet. In certain embodiments, communication network 350 can comprise a collection of interconnected networks.

In one set of embodiments, a local user 312 operating local IWB system 302 can establish a connection between system 302 and remote IWB system 352 for the purpose of engaging in a collaborative session with remote user 362. Once the connection has been established, local camera 306 of local IWB system 302 can begin capturing images (e.g., still-images or video frames) of local surface 304 and can send the captured images to local controller 308. In response, local controller 308 can process the received images to identify physical marks made on local surface 304. Assuming that local surface 304 is initially clear, local controller 304 can generate a video signal that includes a white background (or some other image preselected by local user 312 or remote user 362) and can begin transmitting the video signal to local projector 310 (or local surface 304) for display on local surface 304.

At the same time, remote camera 356 of remote IWB system 352 can begin capturing images (e.g., still-images or video frames) of remote surface 354 and can send the captured images to remote controller 358. In response, remote controller 358 can process the received images to identify physical marks made on remote surface 354. Assuming that remote surface 354 is initially clear, remote controller 358 can generate a video signal that includes a white background (or some other image preselected by local user 312 or remote user 362) and can begin transmitting the video signal to remote projector 360 (or remote surface 354) for display on remote surface 354.

At some point during the collaborative session, local user 312 and/or remote user 362 can begin writing/drawing on his/her respective surface with a writing instrument that employs a disappearing writing medium (e.g., writing instrument 112 of FIG. 1). For example, assume local user 312 makes a physical mark on local surface 304 with such an instrument. Local camera 306 can capture one or more images of local surface 304 while the physical mark is visible and can send the images to local controller 308. Upon receiving the images, local controller 308 can identify the physical mark and can determine an electronic mark corresponding to the physical mark. Local controller 308 can then update the video signal being transmitted to local projector 310 (or local surface 304) to include the electronic mark, thereby causing the electronic mark to become visible to local user 312 on local surface 304 (shown as electronic mark 314).

In certain embodiments, local controller 308 can configure the video signal such that electronic mark 314 visually replaces the disappearing physical mark on local surface 304. For instance, local controller 308 can cause electronic mark 314 to gradually fade into view on local surface 304 as the physical mark fades out of view. This can involve, e.g., determining a time and rate of disappearance of the physical mark, and causing electronic mark 314 to fade in at a time and rate corresponding to the time and rate of disappearance of the physical mark.

In parallel with updating the video signal being transmitted to local projector 310 or local surface 304, local controller 308 can send information pertaining to electronic mark 314 to remote controller 358. Upon receiving this information, remote controller 358 can incorporate the electronic mark into the video signal being transmitted to remote projector 360 (or remote surface 354) such that the electronic mark becomes visible to remote user 362 on remote surface 354 (shown as electronic mark 364).

Subsequent to the flow above, assume that remote user 362 makes a physical mark on remote surface 354 with a writing instrument that uses a disappearing writing medium. Remote camera 306 can capture one or more images of remote surface 354 while the physical mark is visible and can send the images to remote controller 358. Upon receiving the images, remote controller 358 can identify the physical mark and can determine an electronic mark corresponding to the physical mark. Remote controller 358 can then update the video signal being transmitted to remote projector 360 (or remote surface 354) to include the electronic mark, thereby causing the electronic mark to become visible to remote user 362 on remote surface 354 (shown as electronic mark 366).

Like local controller 308, in certain embodiments remote controller 358 can configure the video signal such that electronic mark 366 visually replaces the disappearing physical mark on remote surface 354. For example, remote controller 358 can cause electronic mark 366 to gradually fade into view on remote surface 354 as the physical mark fades out of view. This can involve, e.g., determining a time and rate of disappearance of the physical mark, and causing electronic mark 366 to fade in at a time and rate corresponding to the time and rate of disappearance of the physical mark.

In parallel with updating the video signal being transmitted to remote projector 360 or remote surface 354, remote controller 358 can send information pertaining to electronic mark 366 to local controller 308. Upon receiving this information, local controller 308 can incorporate the electronic mark into the video signal being transmitted to local projector 310 (or local surface 304) such that the electronic mark becomes visible to local user 312 on local surface 304 (shown as electronic mark 316).

In this manner, the physical writings/drawings made by local user 312 on local surface 304 and by remote user 362 on remote surface 354 can be displayed in electronic form at both the local and remote sites. In essence, this provides an environment in which local user 312 and remote user 362 can have the impression of sharing a single writing/drawing surface.

This also enables local user 312 and remote user 362 to interact with the electronic representations of the writings/drawings in various ways. As one example, local user 312 or remote user 362 can manipulate a particular electronic mark displayed on surfaces 304 and 354 by translating, rotating, or scaling it. As another example, local user 312 or remote user 362 can electronically erase a particular electronic mark or a portion thereof (e.g., using an erasing instrument as described with respect to FIG. 1). As yet another example, local user 312 or remote user 362 can make additional physical marks on his/her respective drawing surface. These additional physical marks can be captured, converted into electronic marks, and displayed on both the local and remote surfaces. These types of interactions (and others) can continue indefinitely until either the local user or the remote user ends the session.

It should be appreciated that the interactivity described above can be achieved without requiring any special instrumentation in local surface 304 and/or remote surface 354 to capture user writings/drawings. Rather, local surface 304 and remote surface 354 can be conventional whiteboard surfaces or conventional display devices. Further, it should be appreciated that this interactivity can be achieved without requiring local user 312 or remote user 362 to manually erase any physical marks from their respective surfaces.

FIG. 3 is illustrative and not intended to limit embodiments of the present invention. For example, although only two IWB systems are shown in FIG. 3, any number of such systems can be networked together and can be participants in a collaborative session. Further, the flow described with respect to FIG. 3 can be modified in various ways. For example, in certain embodiments remote user 362 can begin writing prior to local user 312, or the two users can write on their respective surfaces at substantially the same time. Regardless of the sequencing, the physical writings/drawings made by one user can be viewed and interactively manipulated in electronic form at both the local and remote systems.

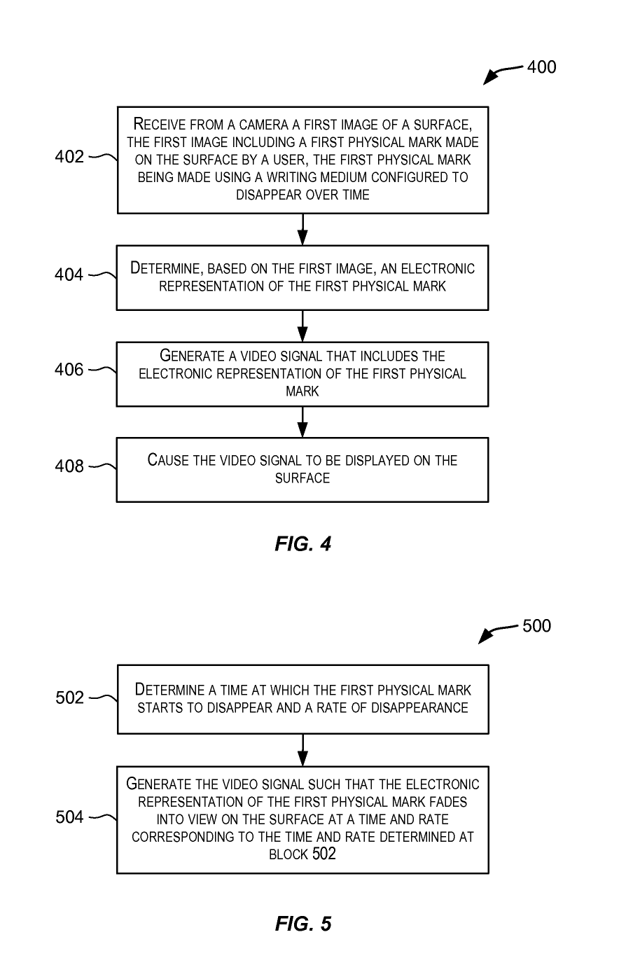

FIG. 4 is a flow diagram of a process 400 that can be performed by IWB system 100 of FIG. 1 to provide interactive whiteboard functionality according to an embodiment of the present invention. In particular, process 400 can be carried out by controller 106 of system 100. Process 400 can be implemented in hardware, software, or a combination thereof. As software, process 400 can be encoded as program code stored on a computer-readable storage medium.

At block 402, controller 106 can receive from camera 104 a first image of surface 102, where the first image includes a first physical mark made on the surface by a user (e.g., user 110). In a particular embodiment, the first physical mark is made with a writing instrument that employs a disappearing writing medium, such as writing instrument 112. The disappearing writing medium can be, e.g., disappearing ink.

At block 404, controller 106 can process the first image and determine, based on that processing, an electronic representation of the first physical mark (i.e., a first electronic mark). The first electronic mark can be, e.g., a raster or vector-based representation of the first physical mark.

In some embodiments, the process of determining the electronic mark can include determining the directionality and/or timing of the physical mark. In these embodiments, controller 106 can, e.g., analyze the saturation of the physical mark as it appears in the image received from camera 104. Based on this information, controller 106 can determine the direction in which the physical mark was drawn, and/or the time at which it was drawn. This directionality and timing information can be stored by controller 106 with the electronic mark information.

Once the first electronic mark has been created, controller 106 can generate a video signal (or update a previously generated video signal) such that the video signal includes the first electronic mark (block 406). Controller 106 can then transmit the generated/updated video signal to projector 108 or surface 102 for display on surface 102.

In certain embodiments, the generated/updated video signal can be configured such that the first electronic mark becomes visible on surface 102 once the first physical mark has disappeared. Thus, from the standpoint of user 110, the first electronic mark can appear to replace the first physical mark. In a particular embodiment, the first electronic mark can fade into view on surface 102 as the first physical mark fades out of view, thereby creating a smooth transition between the disappearing first physical mark and the appearing first electronic mark.

FIG. 5 illustrates a process that can be performed by local controller 106 for achieving this transition. Like process 400, process 500 can be implemented in hardware, software, or a combination thereof. As software, process 500 can be encoded as program code stored on a computer-readable storage medium.

At block 502, controller 106 can determine a time at which the first physical mark begins to disappear, and/or a rate of disappearance of the mark. In one set of embodiments, controller 106 can determine this time and rate based on the time at which the physical mark was originally applied to surface 102. As described above, this timing information can be estimated by analyzing the saturation of the physical mark in the image captured by camera 104.

In another set of embodiments, controller 106 can determine the time and rate of disappearance of the first physical mark based on information regarding writing instrument 112 and/or the disappearing writing medium used by instrument 112. Examples of such information include the type of the disappearing writing medium, the color of the disappearing writing medium, and/or the manufacturer/brand of the writing instrument. In one embodiment, this information can be manually provided by user 110 to controller 106. In an alternative embodiment, this information can be automatically determined by controller 106 by, e.g., analyzing the image captured by camera 104.

At block 504, controller 106 can configure the video signal generated at block 406 of FIG. 4 such that the first electronic mark fades into view on surface 102 at a time and rate corresponding to the time and rate of disappearance of the first physical mark.

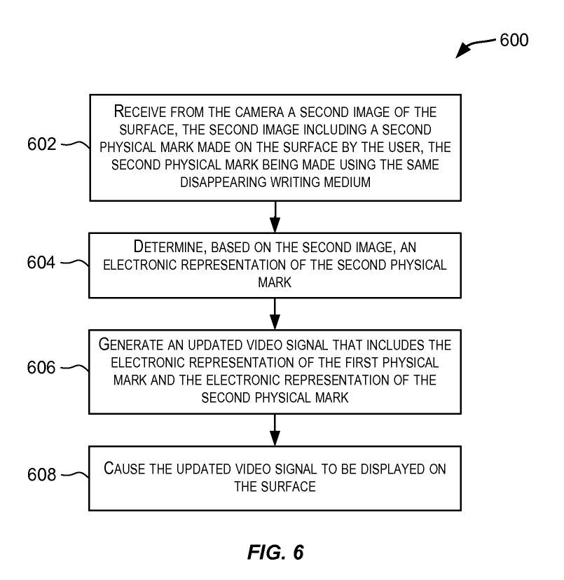

Once the first physical mark has been visually replaced with the first electronic mark on surface 102, user 110 can interact with the displayed video signal by making further marks on surface 102. FIG. 6 illustrates a process 600 that can be performed by controller 106 for processing a second physical mark made by user 110. Like processes 400 and 500, process 600 can be implemented in hardware, software, or a combination thereof. As software, process 600 can be encoded as program code stored on a computer-readable storage medium.

At block 602, local controller 106 can receive from camera 104 a second image of surface 102, where the second image includes the second physical mark made by user 110. In various embodiments, the second physical mark can be made using the same disappearing writing medium as the first physical mark described with respect to FIG. 4.

At block 604, controller 106 can determine, based on the second image, an electronic representation of the second physical mark (i.e., a second electronic mark). In one set of embodiments, the second image captured by camera 104 can be configured such that it does not include the first electronic mark displayed on surface 102 at block 408 of FIG. 4. For example, the video signal displayed on surface 102 may have been configured to display one or more frames per second that exclude the first electronic mark, and the second image may have been captured during those one or more frames. In these embodiments, controller 106 does not need to perform any particular processing to identify the second physical mark in the second image.

In another set of embodiments, the second image can be configured such that it includes both the first electronic mark (as displayed on surface 102) and the second physical mark. In these embodiments, controller 106 can subtract (using, e.g., conventional image processing techniques) the first electronic mark from the second image. In this manner, controller 106 can distinguish the first electronic mark from the second physical mark.

Once the second electronic mark has been created, controller 106 can update the video signal generated at block 406 such that the video signal includes the second electronic mark, in addition to the first electronic mark (block 606). Controller 106 can then transmit the updated video signal to projector 108 or surface 102 for display on surface 102. Like the first electronic mark, controller 106 can cause the second electronic mark to fade into view on surface 102 as the second physical mark fades out of view, thereby creating a smooth transition between the disappearing second physical mark and the appearing second electronic mark.

It should be appreciated that processes 400, 500, and 600 are illustrative and that variations and modifications are possible. For example, steps described as sequential can be executed in parallel, order of steps can be varied, and steps can be modified, combined, added, or omitted. One of ordinary skill in the art would recognize other variations, modifications, and alternatives.

In certain embodiments, controller 106 of IWB system 100 can carry out a calibration process to map the coordinate space of the images captured by camera 104 to the coordinate space of the video signal image generated by controller 106. Without this calibration, the electronic marks determined by controller 106 may not visually align with their corresponding physical marks when displayed on surface 102. In one embodiment, the calibration process can be carried out each time the physical position of surface 102, camera 104, and/or projector 108 is changed. In other embodiments, the calibration process can be carried out each time IWB system 100 is powered on.

In one set of embodiments, the calibration process can comprise generating and displaying a “test” video signal on surface 102 that includes several calibration points. These calibration points can be located at, for example, the four corners of the video signal image. Upon viewing the test video signal, user 110 can adjust the position of projector 108 (or surface 102) such that the calibration points substantially align with the four corners of surface 102. User 110 can also adjust the position of camera 104 such that the camera can view the entirety of surface 102. Once projector 108, surface 102, and camera 104 are appropriately positioned, camera 104 can capture an image of surface 102 that includes the calibration points, and controller 106 can determine, based on the captured image, how to map the coordinate space of the captured image to the coordinate space of the video signal image. In the case of networked IWB systems, the local and remote systems can be calibrated separately using this technique and the coordinate space of the local video signal image can be mapped to the coordinate space of the remote video signal image.

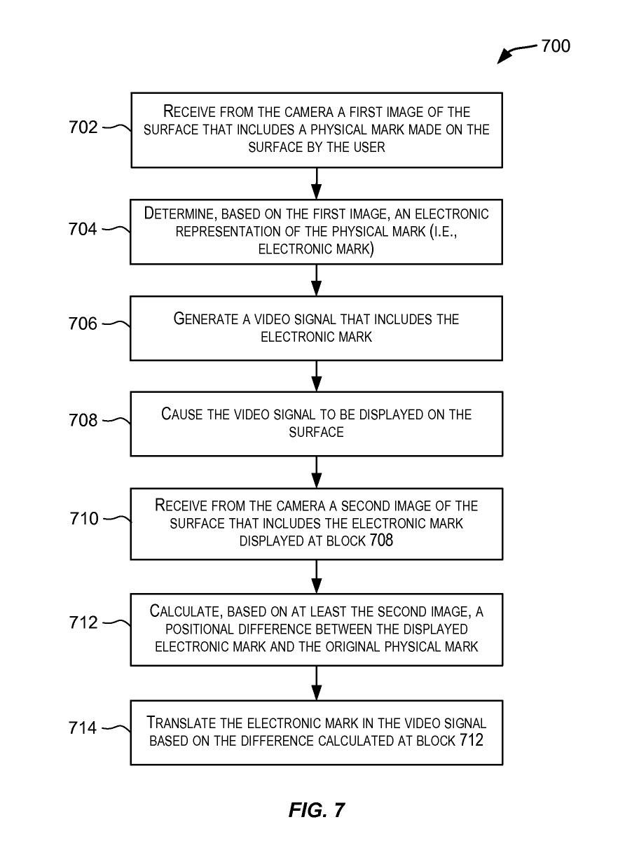

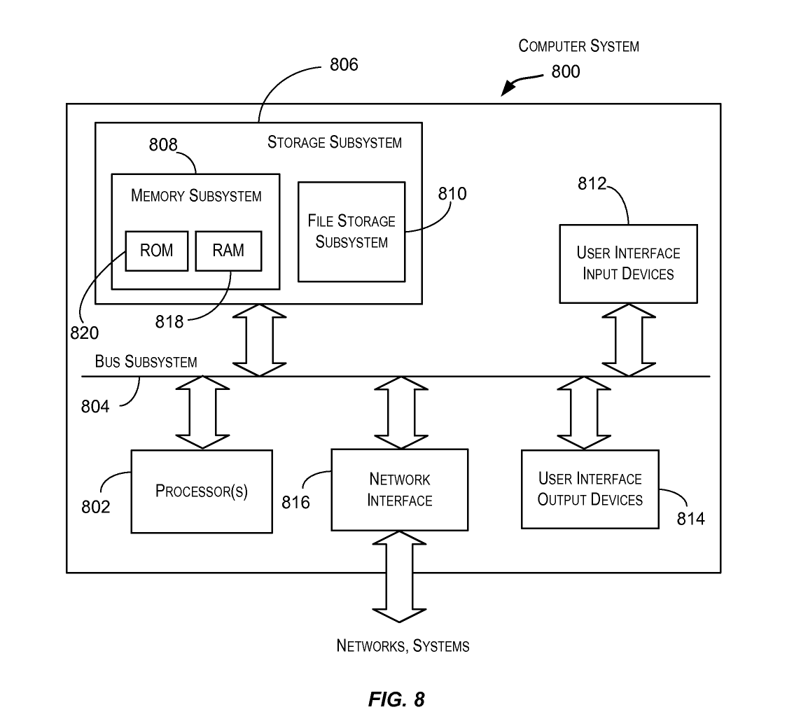

In another set of embodiments, calibration can be performed by controller 106 “on-the-fly” while system 100 is being used by user 110, without any need for generating and displaying an initial test video signal. One example of such a calibration process is depicted as process 700 in FIG. 7. Process 700 can be implemented in hardware, software, or a combination thereof. As software, process 700 can be encoded as program code stored on a computer-readable storage medium.

At block 702, controller 106 can receive a first image from camera 104 that includes a physical mark made on surface 102 by user 110 (using, e.g., writing instrument 112). For simplicity, assume that the physical mark is a straight line segment completely defined by its two end points (in alternative embodiments, the physical mark can be any type of stroke or indication).

At blocks 704 and 706, controller 106 can determine, based on the first image, an electronic representation of the physical mark (i.e., an electronic mark), and can generate/update a video signal that includes the electronic mark. Controller 106 can then cause the video signal to be displayed on surface 102 (block 708). Since system 100 has not yet been calibrated, controller 106 does not know the correct location of the electronic mark within the coordinate space of the video signal image, and thus estimates where the electronic mark should be positioned.

At block 710, controller 106 can receive a second image from camera 104 that includes the electronic mark displayed at block 708. Controller 106 can then calculate, based on at least the second image, the positional difference between the displayed electronic mark and the original physical mark (block 712). In one set of embodiments, the second image can be taken before the physical mark disappears, and thus the second image can include both the displayed electronic mark and the physical mark. In these embodiments, controller 106 can determine the positional difference between the displayed electronic mark and the physical mark using only the second image.

In another set of embodiments, the second image can be taken after the physical mark has disappeared, and thus the second image can include only the displayed electronic mark. In these embodiments, controller 106 can determine the positional difference between the displayed electronic mark and the physical mark by comparing the first and second images.

The calculation performed at block 712 can be carried out in a number of different ways. If the physical mark goes from point A to point B (in the first or second image) and if the electronic mark goes from point A′ to point B′ (in the second image), controller 106 can calculate the positional difference by calculating A′ minus A and B′ minus B. If the physical mark is a more complex shape (e.g., a curved line), controller 106 can identify three or more points in the physical mark and map those points to corresponding points in the electronic mark.

Once the positional difference between the marks is calculated, controller 106 can translate the electronic mark in the video signal based on the difference, thereby aligning the electronic mark with the physical mark (block 714). Further, controller 106 can apply this translation to any further electronic marks determined by the controller. In this manner, the system can be appropriately map the coordinate space of the images captured by camera 104 to the coordinate space of the video signal image generated by controller 106.

In the case where IWB system 100 is networked with a remote IWB system (as shown in FIG. 3), controller 106 can send the representation of the electronic mark determined at block 704 to the remote controller of the remote IWB system, which can generate a video signal including the electronic mark for display on the remote surface. The remote controller can then receive an image of the remote surface as captured by the remote camera, and can compare the image to the generated video signal to determine any positional differences between the marks in the captured image and the video signal image. The remote controller can then translate the electronic mark in the video signal based on the difference, thereby calibrating the remote system.

It should be appreciated that process 700 is illustrative and that variations and modifications are possible. For example, steps described as sequential can be executed in parallel, order of steps can be varied, and steps can be modified, combined, added, or omitted. One of ordinary skill in the art would recognize other variations, modifications, and alternatives.

FIG. 8 is a simplified block diagram of a computer system 800 according to an embodiment of the present invention. In one set of embodiments, computer system 800 can be used to implement controller 106 illustrated in FIG. 1 and described above. As shown in FIG. 8, computer system 800 can include one or more processors 802 that communicate with a number of peripheral subsystems via a bus subsystem 804. These peripheral subsystems can include a storage subsystem 806 comprising a memory subsystem 808 and a file storage subsystem 810, user interface input devices 812, user interface output devices 814, and a network interface subsystem 816.

Bus subsystem 804 can provide a mechanism for enabling the various components and subsystems of computer system 800 to communicate with each other as intended. Although bus subsystem 804 is shown schematically as a single bus, alternative embodiments of the bus subsystem can utilize multiple busses.

Network interface subsystem 816 can serve as an interface for receiving data from and transmitting data to other systems and/or networks. For example, network interface subsystem 816 can enable the controller of one IWB system (e.g., local IWB system 302 of FIG. 3) to communicate with the controller of another remotely located IWB system (e.g., remote IWB system 352 of FIG. 3) via a communication network such as the Internet.

User interface input devices 812 can include a keyboard, pointing devices such as a mouse, trackball, touchpad, or graphics tablet, a scanner, a barcode scanner, a touch screen incorporated into the display, audio input devices such as voice recognition systems, microphones, and other types of input devices. In general, use of the term “input device” is intended to include all possible types of devices and mechanisms for inputting information to computer system 800.

User interface output devices 814 can include a display subsystem, a printer, a fax machine, or non-visual displays such as audio output devices, etc. The display subsystem can be a cathode ray tube (CRT), a flat-panel device such as a liquid crystal display (LCD), or a projection device. In general, use of the term “output device” is intended to include all possible types of devices and mechanisms for outputting information from computer system 800.

Storage subsystem 806 can provide a computer-readable storage medium for storing the basic programming and data constructs that provide the functionality of the present invention. Software (e.g., programs, code modules, instructions, etc.) that when executed by a processor provide the functionality of the present invention can be stored in storage subsystem 806. These software modules or instructions can be executed by processor(s) 802. Storage subsystem 806 can also provide a repository for storing data used in accordance with the present invention. Storage subsystem 806 can comprise memory subsystem 808 and file/disk storage subsystem 810.

Memory subsystem 808 can include a number of memories including a main random access memory (RAM) 818 for storage of instructions and data during program execution and a read only memory (ROM) 820 in which fixed instructions are stored. File storage subsystem 810 can provide a non-transitory persistent (non-volatile) storage for program and data files, and can include a hard disk drive, a floppy disk drive along with associated removable media, a Compact Disk Read Only Memory (CD-ROM) drive, an optical drive, removable media cartridges, and/or other like storage media.

Computer system 800 can be of various types including a personal computer, a phone, a portable computer, a workstation, a network computer, or any other data processing system. Due to the ever-changing nature of computers and networks, the description of computer system 800 depicted in FIG. 8 is intended only as a specific example for purposes of illustrating one embodiment of a computer system. Many other configurations having more or fewer components than the system depicted in FIG. 8 are possible.

Although specific embodiments of the invention have been described, various modifications, alterations, alternative constructions, and equivalents are also encompassed within the scope of the invention. For example, embodiments of the present invention are not restricted to operation within specific environments or contexts, but are free to operate within a plurality of environments and contexts. Further, although embodiments of the present invention have been described using a particular series of transactions and steps, these are not intended to limit the scope of inventive embodiments.

Yet further, while embodiments of the present invention have been described using a particular combination of hardware and software, it should be recognized that other combinations of hardware and software are also within the scope of the present invention. For example, embodiments of the present invention can be implemented only in hardware, only in software, or using combinations thereof.

The specification and drawings are, accordingly, to be regarded in an illustrative rather than a restrictive sense. It will be evident that additions, subtractions, deletions, and other modifications and changes may be made thereunto without departing from the broader spirit and scope of the invention.

What is claimed is:

1. A method comprising:
receiving, by a computer system, a first image of a surface, the first image including a first physical mark made on the surface by a user, the first mark being made using a writing medium configured to disappear over time;
determining, by the computer system based on the first image, an electronic representation of the first physical mark;
generating, by the computer system, a video signal that includes the electronic representation of the first physical mark; and
causing, by the computer system, the video signal to be displayed on the surface,
wherein the electronic representation of the first physical mark visually replaces the first physical mark on the surface as the first physical mark disappears.

2. The method of claim 1 wherein the video signal is displayed on the surface such that the electronic representation of the first physical mark appears at the same location on the surface that the first physical mark was originally made by the user.

3. The method of claim 1 further comprising determining a time at which the first physical mark starts to disappear.

4. The method of claim 3 wherein the video signal is generated such that the electronic representation of the first physical mark starts to fade into view on the surface at the time at which the first physical mark starts to disappear.

5. The method of claim 1 further comprising determining a rate of disappearance of the first physical mark.

6. The method of claim 5 wherein the video signal is generated such that the electronic representation of the first physical mark fades into view on the surface at a rate corresponding to the rate of disappearance of the first physical mark.

7. The method of claim 5 wherein the rate of disappearance is determined based on information pertaining to the writing medium.

8. The method of claim 7 wherein the information pertaining to the writing medium comprises a color of the writing medium or a manufacturer of the writing medium.

9. The method of claim 1 wherein the video signal is generated such that, for at least one frame per second, the video signal does not include the electronic representation of the first physical mark.

10. The method of claim 9 further comprising:
receiving a second image of the surface, the second image including a second physical mark made on the surface by the user, the second physical mark being made using the writing medium;
determining, based on the second image, an electronic representation of the second physical mark;
generating an updated video signal that includes the electronic representation of the first physical mark and the electronic representation of the second physical mark; and
causing the updated video signal to be displayed on the surface.

11. The method of claim 10 wherein the second image is captured by a camera during the at least one frame where the video signal does not include the electronic representation of the first physical mark.

12. The method of claim 10 wherein the electronic representation of the second physical mark visually replaces the second physical mark on the surface as the second physical mark disappears.

13. The method of claim 1 further comprising transmitting the electronic representation of the first physical mark to a remote system.

14. The method of claim 1 wherein the writing medium is disappearing ink.

15. The method of claim 1 wherein the writing medium is configured to remain visible for at least one second and to disappear within ten seconds.

16. The method of claim 1 wherein the surface is a conventional whiteboard.

17. The method of claim 1 wherein causing the video signal to be displayed on the surface comprises transmitting the video signal to a projector for projection onto the surface.

18. The method of claim 1 wherein the surface is an LCD display, and wherein causing the video signal to be displayed on the surface comprises transmitting the video signal to the LCD display.

19. A non-transitory computer-readable storage medium having stored thereon program code executable by a processor, the program code comprising:
code that causes the processor to receive an image of a surface, the image including a physical mark made on the surface by a user, the physical mark being made using a writing medium that is configured to disappear over time;
code that causes the processor to determine, based on the image, an electronic representation of the physical mark;
code that causes the processor to generate a video signal that includes the electronic representation of the physical mark; and
code that causes the processor to transmit the video signal for display on the surface,
wherein the electronic representation of the physical mark visually replaces the physical mark on the surface as the physical mark disappears.

20. A system comprising:
a processor configured to:
receive an image of a surface, the image including a physical mark made on the surface by a user, the physical mark being made using a writing medium configured to disappear over time;
determine, based on the image, an electronic representation of the physical mark;
generate a video signal that includes the electronic representation of the physical mark; and
cause the video signal to be displayed on the surface,
wherein the electronic representation of the physical mark visually replaces the physical mark on the surface as the physical mark disappears.
